(19) United States
(12) Patent Application Publication
(10) Pub. No.: US 2026/0269926 A1
(43) Pub. Date: Sep. 10, 2026

(54) SET OF TELECOMMUNICATION CHANNELS, APPARATUS AND PROCESS FOR MULTICHANNEL TELECOMMUNICATION

(71) Applicant: ROTONIUM S.R.L., GEMONA DEL FRIULI (IT)

(72) Inventors: Roberto SIAGRI, Artegna (IT); Fabrizio TAMBURINI, Venezia (IT)

(73) Assignee: ROTONIUM S.R.L., GEMONA DEL FRIULI (IT)

(21) Appl. No.: 19/161,282

(22) PCT Filed: Feb. 15, 2024
(86) PCT No.: PCT/IB2024/051410

§ 371 Date: Sep. 1, 2025

(30) Foreign Application Priority Data
Mar. 1, 2023 (IT) 102023000003663

(51) Int. Cl. H04B 7/10

(52) U.S. Cl. CPC H04B 7/10

(57) ABSTRACT

An assembly of telecommunication channels includes a plurality of first channels in the same carrier frequency and at least one first carrier electromagnetic wave carrying orbital angular momentum, i.e., with the phase twisted around a predetermined twisting axis. The wavefront of said wave is divided in space into sectors distinct from each other, where each of the first channels includes the orbital angular momentum of the first wave; and one of the sectors (of the first wave) in which the wave is modulated differently from the other sectors.

The present invention relates to a set of telecommunication channels, an apparatus and a process for multi-channel telecommunications.

The invention was made with reference to both analog and digital telecommunications.

Said telecommunication is at least of transmission and reception, but two-way communication is not excluded.

The invention was made with particular reference to the field of wireless transmissions, e.g. radio, however other types of transmission are not excluded.

The invention was made in reference to both a single-user and multi-user transmission.

### STATE OF THE ART

In the telecommunication sector, there has always been a pressing problem of increasing data transfer capacity.

In general, channels are known as defined each by an electromagnetic wave with a different frequency.

Professor Fabrizio Tamburini, one of the inventors of the present invention, however, has in the past experimented with the possibility of transmitting several channels in the same frequency.

The experiment is known as the “San Marco” experiment as it took place in St. Mark's Square in Venice on Jun. 24, 2011.

During the experiment, an ordinary electromagnetic wave was transmitted at the same time as a twisted electromagnetic wave, i.e., carrying orbital angular momentum, also called OAM, and both were transmitted in the same frequency and modulated to carry the same information (a video signal).

It was found that the waves remained distinct and it was possible to switch from receiving one to receiving the other and vice versa, thus concluding that each could define an independent communication channel in the same frequency. This certainly serves the primary purpose of increasing the data transfer capacity in the same frequency, even possibly multi-user, exploiting one channel for each user.

In addition to the problem of increasing the data transfer channels, there is also the pressing problem of ensuring the quality of the data transmitted, limiting or eliminating the phenomena of uncontrolled interference.

The inventors, following the San Marco experiment, continued their studies in the direction of further increasing the number of channels suited to transfer data with a high-quality standard.

The purpose of the present invention is to overcome all or part of the problems of the known technique.

In particular, a preferred purpose of the present invention is to enable high multi-channel data transmission with high quality.

A preferred purpose of the present invention is to define a plurality of channels in the same frequency, each with a high transmission quality.

Another further preferred purpose is to define a plurality of transmission channels that can also be used for transmission in deliberately disturbed conditions for protective purposes, generally called jamming conditions.

Another further preferred purpose is to define a data transmission that is easily and clearly distinguishable by a predestined receiver within a deliberately disturbed communication for protective purposes (jamming conditions).

### General Introduction

The purposes are achieved by the invention as defined in the attached claims, which are incorporated as an integral part of this description.

In particular, according to its first general aspect, the present invention concerns a set of telecommunication channels comprising a plurality of first channels (CH11, CH12) in the same carrier frequency, the set including at least one first carrier electromagnetic wave carrying orbital angular momentum (OAM), i.e., the phase twisted around a with predetermined direction in space (W1) characterized by an orbital angular momentum (OAM1), OAM for the sake of brevity, the wavefront of said wave being divided in space into sectors (S1 . . . . Sp) distinct from each other (i.e., not overlapping), where each of said first channels is characterized by:
said orbital angular momentum (OAM1) of said first wave (W1);
one of said sectors (S1 . . . . Sp) of said first wave (W1) in which said wave is modulated differently from the other sectors.

We note that, for the purposes of the present invention, the carrier frequency of a channel is always considered to be the same even if the wave is frequency modulated within a predetermined bandwidth. In other words, the carrier frequency of the channel has a predetermined frequency modulation tolerance given by the predetermined bandwidth.

According to a second aspect, the invention concerns a multi-channel telecommunications apparatus comprising at least one radio transmitting device (2, 102), hereinafter referred to as Tx for brevity, and a radio receiving device (3,103), hereinafter referred to as Rx for brevity, characterized by the fact that:
the Tx transmission device (2, 102) comprises:
   a plurality of transmitting antennas (T1-Tn);
   a plurality of modulation sections (S1-Sp) each defined by a group of said antennas operationally associated with each other;
   piloting means (10), configured to drive said T1-Tn antennas to generate at least one carrier electromagnetic wave with the phase twisted around a predetermined direction in space (W1) characterized by an orbital angular momentum (OAM1) and by a carrier frequency;
   modulation means (11), operationally associated with said sections (S1-Sp) to modulate corresponding sectors of the front of said electromagnetic wave (W1) with orbital momentum angular (OAM), where the modulations of sectors are independent of each other and define respective channels (Ch11, Ch12, Ch21, Ch22) in the same carrier frequency.

According to a third aspect, the invention relates to a multi-channel telecommunications process comprising the following steps:
generating at least one carrier electromagnetic wave carrying orbital angular momentum (OAM), i.e., with the phase twisted around a predetermined direction in space (W1) characterized by an orbital angular momentum (OAM1) and by a carrier frequency;
dividing the wavefront into sectors (S1-Sp) modulated independently of each other and considering each one as a transmission channel (Chx, x) in said carrier frequency;
receiving the wavefront and discriminating said channels.

### DETAILED DESCRIPTION

Further features and advantages of the present invention will be best seen in the following detailed description of its preferred applications, made with reference to the attached drawings, and given as an indication and not as a limitation. In such drawings:

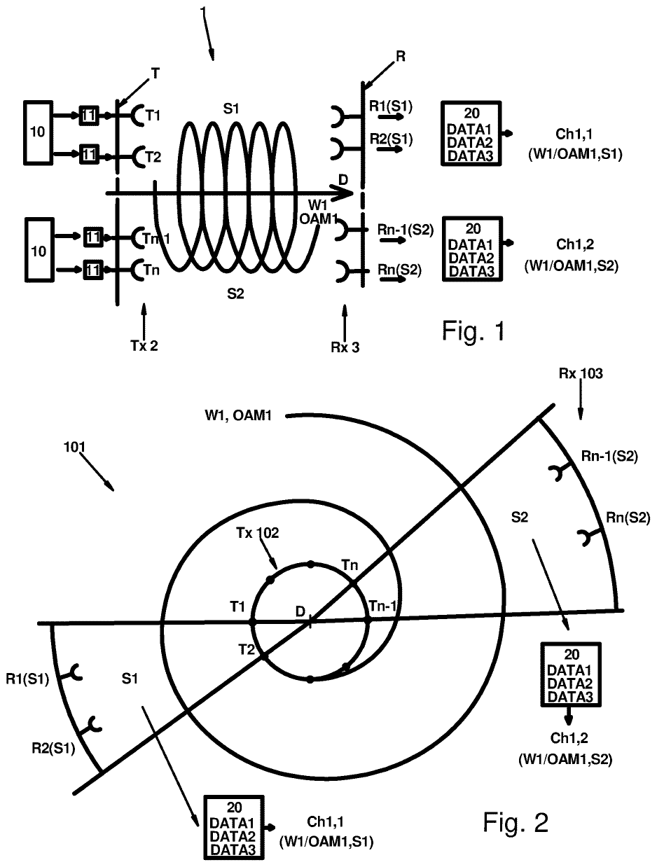

FIG. 1 schematically shows a telecommunication apparatus according to the present invention, and the first telecommunication channels defined by it;

FIG. 2 shows a telecommunication apparatus according to the present invention with a different arrangement of the antennas compared to the apparatus in FIG. 1, seen in a plane orthogonal to the direction of propagation, where said first channels are highlighted;

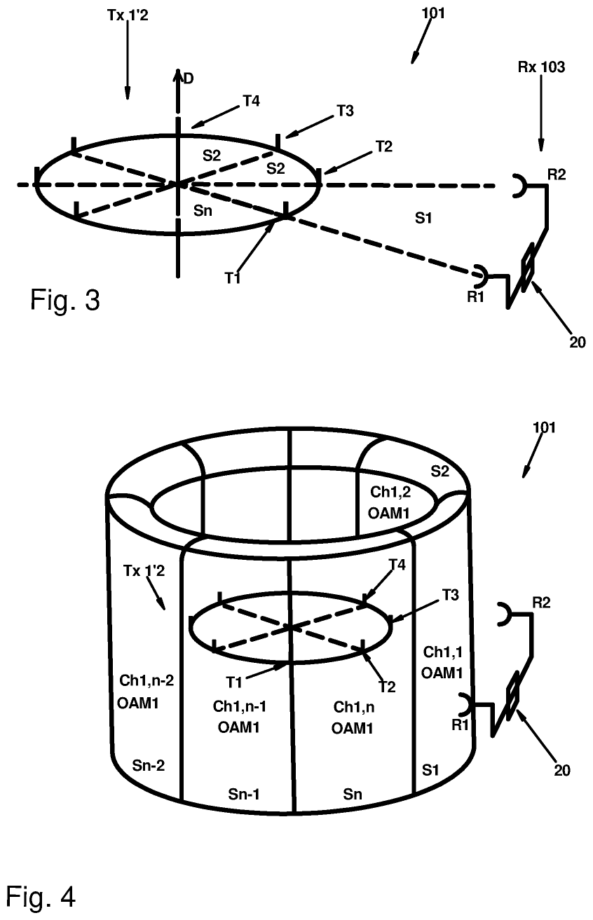

FIG. 3 schematically shows the apparatus of FIG. 2 in perspective view, where the division into sections of the radio transmission device is highlighted;

FIG. 4 shows the sectors of the cylindrical wavefront of the twisted electromagnetic wave of FIGS. 2 and 3, subdivided by the sections of the radio transmission device;

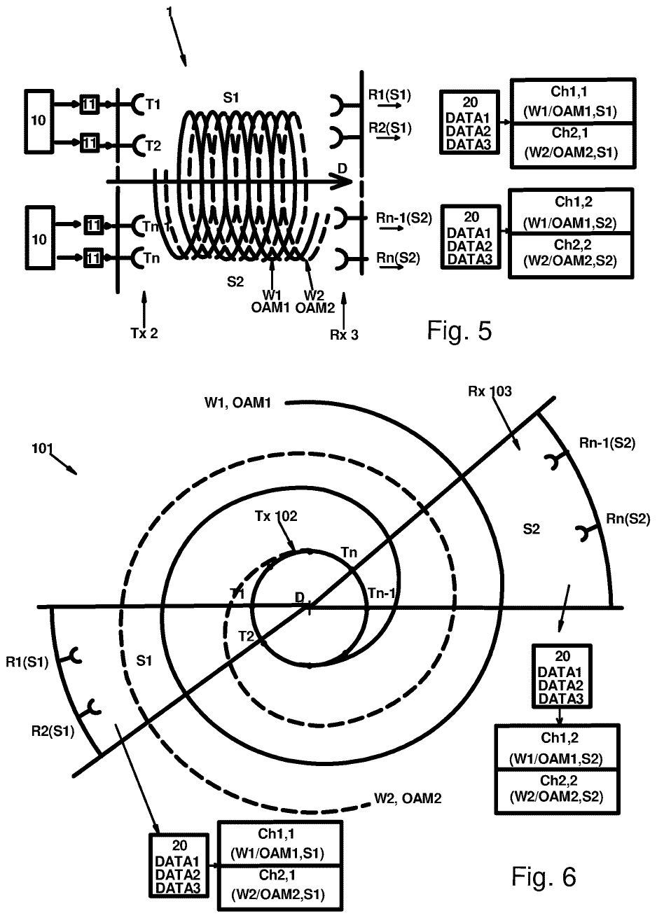

FIG. 5 shows the first and second channels according to the present invention generated through the same apparatus as in FIG. 1;

FIG. 6 shows the first and second channels according to the present invention generated through the same apparatus as in FIGS. 2 to 4;

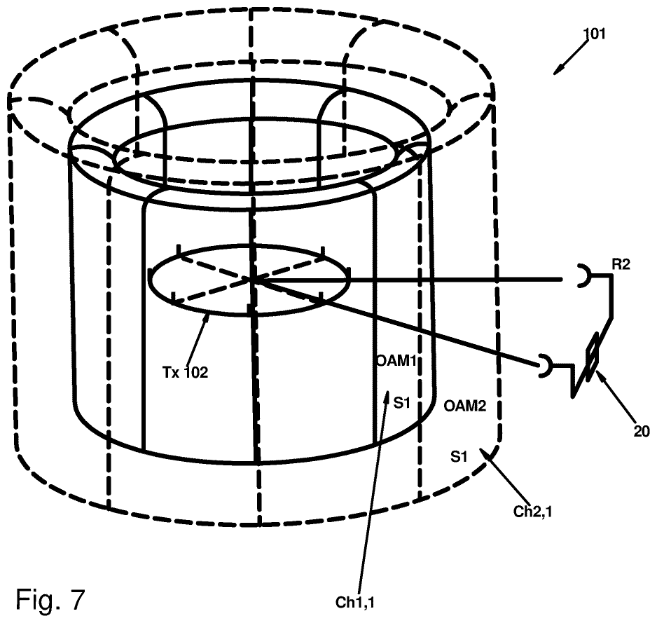

FIG. 7 shows the sectors of the cylindrical wavefronts of the twisted electromagnetic waves, generated by the apparatus in FIG. 6.

With reference to FIG. 1, a first radio telecommunication apparatus is represented according to the present invention, indicated as a whole by reference number 1.

Said apparatus s at least one radio transmitting device 2, hereinafter referred to as Tx for brevity, and one radio receiving device 3, hereinafter referred to as Rx for brevity.

Apparatus 1 defines between Rx and Tx a set of telecommunication channels having in common the same frequency and the fact that they are defined by an electromagnetic wave in a carrier frequency with the phase twisted around a predetermined direction in space, hereinafter referred to as twisted wave or carrier wave for brevity.

FIG. 1 in particular shows a plurality of first telecommunication channels Ch1,1 and Ch1,2, which have in common:
the same carrier electromagnetic wave W1;
the same angular momentum OAM1 of said wave W1.

Said channels are distinct from each other in that each corresponds to a respective sector S1-Sp of the wavefront of said twisted carrier electromagnetic wave W1.

In each sector, wave W1 is modulated differently than in the other sectors. Said modulation is preferably in at least one of the following: phase, amplitude, polarization, frequency, path diversity, and other known methods.

Frequency modulation is intended as a modulation of the carrier frequency within a predetermined bandwidth, in which case for the purposes of the present invention the corresponding channels are considered carrier frequency channels. In general, the carrier frequency is preferably in the order of MHz, while the modulation bandwidth is in the order of magnitude of KHz. For example, for a carrier frequency of 88.8 MHz the modulation bandwidth can be +/−100 KHz.

In general, the bandwidth is therefore preferably a fraction of the frequency of the carrier wave (or, in jargon, of the “carrier”).

The channels are centered on the carrier wave frequency, where an FM radio “tunes in” for example; the frequency modulation does not appreciably change the OAM, as those of digital and phase modulations such multiplexing (MUX) like PSK, QPSK, QAM and so on, such as digital TV MUXes for example, are a small perturbation in phase (a controlled ripple) on the fusillo azimuthal phase typical of each of the OAM states. Each channel in that chosen OAM state acts as a “phase carrier” on a channel characterized by a carrier frequency.

To sum up, we therefore have the possibility to make a frequency modulation on the carrier frequency and a phase modulation on the carrier phase shape characteristic of each OAM state. Each OAM state obviously has its own phase imprint which is like a 1-layer spiral, with OAM 1=+1 if levorotatory or 1=−1 if dextrorotatory or with 2 or more layers, ideally up to spirals with infinite layers. A non-limiting figurative example is fusilli, i.e., the well-known pasta shape.

The Tx transmission device in general includes:
a plurality of T1-Tn transmission antennas;
a plurality of S1-Sp modulation sections, each defined by a group said antennas operationally of associated with each other;
piloting means 10, configured to drive said T1-Tn antennas to generate at least one electromagnetic wave, preferably a plurality of them (W1-Wk), with respective desired and distinct angular orbital momenta (OAM) for each wave;
modulation means 11, operationally associated with said sections (S1-Sp) to modulate corresponding sectors of the fronts of said electromagnetic waves with orbital angular momentum (OAM), where the modulations of the sectors of each wave are independent of each other.

In this way, every single electromagnetic wave with OAM is used as the main signal carrier and each sector of each of these waves corresponds to a channel.

Preferably the piloting means 10 modulate in at least one of the following: amplitude, frequency, path diversity and phase.

Preferably, the modulation means 11 modulate in at least one of the following: amplitude, frequency, path diversity and phase.

As a practical figurative example, we can imagine a parallel with a well-known pasta shape. Let's imagine, for example, the spatial structure of the OAM “carrier” as a fusillo (the screw shape of a well-known pasta); we can imagine each fusillo associated with OAM as having lines or small undulations that do not significantly alter its main flap structure, i.e., they always remain fusilli. To have an OAM channel, we need a fusillo with a number of flaps equal to the OAM L value, therefore the structure must be maintained, and the various modulations do nothing but add a small structure on top of the main fusillo structure. The modulation in phase can be thought of as a groove in the fusillo, and in amplitude as a variation in the size of the fusillo, but in any case they preserve the average topology of the OAM phase structure.

FIG. 1 shows the example of a single twisted electromagnetic wave W1 where the S1-Sp sectors of the corresponding wavefront define as many channels Ch1,1 (W1/OAM1, S1) and Ch1,2 (W1/OAM1, S2). Wave W1 has orbital angular momentum OAM1.

FIG. 5 shows the general example of two twisted electromagnetic waves W1, W2 generated by the same Tx of FIG. 1 with respective orbital angular momenta OAM1 and OAM2, where the wavefronts are divided into the same sectors S1-Sp. The second wave W2 therefore doubles the number of channels, as it associates the same number of channels of wave W1 to its OAM2. Additional channels are indicated with Ch2,1 (W2/OAM2, S1) and Ch2,2 (W2/OAM2, S2).

The Rx receiving device is placed at a distance from Tx and includes:
a plurality of R1-Rm receiving antennas;
discrimination means (20), operationally associated with said receiving antennas and configured to carry out amplitude and phase measurements of the electromagnetic field in correspondence with different reception points (R) in order to acquire first data indicative of the individual discrimination of (DATA1) said electromagnetic waves W1-Wk and to process them into second data (DATA2) indicative of the discrimination in sectors S1, . . . . Sp of each wavefront.

Finally, the discrimination means (20) are configured to process said second DATA2 data in order to obtain third DATA3 data that allow to discriminate in different S1-Sp sectors of the various wavefronts the Chx, x data transmission channels, if present.

FIG. 1 shows an example of transmitting device 2 where the T1-Tn antennas are arranged to define an (ideal) transmitting surface T and a transmitting direction D orthogonal to it. Such an ideal transmission surface is, for example, a transmission plane. Preferably, the antennas are arranged in a radial pattern around a D axis orthogonal to the transmitting surface. Overall, the wavefront is omnidirectional and is modulated sector by sector. If we need to communicate with an Rx target moving with respect to Tx or in any case towards a predetermined direction, it is the modulation that points or follows the receiver, while the carrier wave remains omnidirectional.

More generally, there can be two cases: in the first case the wave is omnidirectional and therefore the D axis is orthogonal to the propagation plane and the modulation of the omnidirectional carrier wave towards a predetermined Rx receiver is done using part of the antennas. In the second case, the wave is not omnidirectional and propagates from point A to point B. Also in this case it is possible to modulate various sectors independently, for instance like a satellite transmission to different users, which broadcasts to Earth but transmits different channels in different directions always using different modulations along different directions; in this case the D axis coincides with the propagation axis.

In the example in FIG. 1, the receiving antennas R1-Rm are arranged as to define an (ideal) receiving surface R intersecting the wavefront and orthogonal to the transmission direction D—this ideal receiving surface is e.g. a receiving plane.

In the following, alternative forms of implementation of the invention will be described, where elements that are the same or similar to the previous ones will be indicated with the same reference numbers, or with the same numbers increased by 100 or multiples thereof.

FIGS. 2-4 and 6-7 show an alternative form of implementation of a radio telecommunication system denoted as a whole by reference number 101, which differs from apparatus 1 described above substantially by a different reciprocal arrangement of the transmitting and receiving antennas.

In particular, the Tx 102 transmitting device has the T1-Tn antennas arranged as to define a transmitting surface T and a transmission direction parallel to said surface, e.g., with a cylindrical or conical wavefront.

The RX 103 receiving device has the R1-Rm receiving antennas arranged as to envelop the propagation wavefront transmitted by Tx.

For example, when said wavefront is cylindrical or conical around said D axis, the receiving antennas R1-Rn are arranged in a radial pattern around said axis.

For example, the R1-Rm receiving antennas can be arranged to define a plurality of receiving surfaces concentric to the D axis.

For example, the discrimination means 20 of the Rx 103 device can be configured to perform an anamorphic transformation of affine homology of the wavefront propagating with conical or cylindrical symmetry centered on the D axis.

The two devices 1 and 101 are able to generate the same channels.

For the sake of completeness, we note that figure shows the general 7 example of two twisted electromagnetic waves W1, W2 generated by the same Tx of FIGS. 2, 3 and 4 with their respective orbital angular momenta OAM1 and OAM2 where the wavefronts are divided into the same S1-Sp sectors. The second wave W2 therefore doubles the number of channels, as it associates the same number of channels of wave W1 to its OAM2. Additional channels are indicated with Ch2,1 (W2/OAM2, S1) and Ch2,2 (W2/OAM2, S2).

In general, in practice multiple channels can be advantageously associated with each OAM wave by independently modulating non-overlapping sectors of the wavefront.

In other words, the modulation in the S1-Sp sectors of the wavefronts of each OAM wave can be considered as a real novelty, which identifies at least one of the Chx, x data channels that are transmitted simultaneously, on the same carrier frequency, in the same OAM mode either in an omnidirectional direction or along one direction, fixed or selectable.

This represents a major element of differentiation with respect to the apparatuses of known art.

In the present invention, in general, each twisted OAM electromagnetic wave, received in correspondence with a generic reception plane, is associated with a data channel Chx, x for which the identifying quantity is constituted by the orbital angular momentum OAM of the W1-Wk wave itself.

In order to detect the identifying quantity, i.e. the OAM, of a given data channel Chx, x, it is therefore necessary to know the exact rotation value of the wavefront phase of the electromagnetic wave received in correspondence with the reception plane R, and then to perform phase measurements of the electromagnetic field in correspondence with the chosen wavefront sector and on the corresponding receiving surface R.

In practice, only one or more angular sectors of the chosen OAM wave are modulated to communicate with a desired receiver Rx by means of the appropriate selection of some of the antennas that make up the Tx array. Those that are used to communicate toward a chosen Rx receiving user will transmit codes, symbols, or other types of signals modulated on the wave with OAM, while the rest of the antennas can, for example, contribute to jamming by sending random symbols or signals, or communicate with other Rx users.

The OAM transmission of the present invention is called “selective” because it preferably activates one or more T1-Tn antennas oriented towards one or more Rx receiving devices by means of an electronic feedback (not excluding the mechanical one) which appropriately activates one or more antennas that transmit OAM and directs the desired transmission within certain angular sectors of the omnidirectional beam that identify the directions of the receiving stations (which can in turn be other jamming sources). This system also makes it possible to direct and tighten at will each angular sector (or cone) of communication where the communication modulation takes place. The rest of the wavefront can be a source of jamming, which takes place by means of a modulation to be chosen appropriately.

### General Definitions

As is known from the literature, the OAM of an electromagnetic wave is a quantity that uniquely characterizes an azimuthal phase distribution in the wavefront on a plane orthogonal to the propagation of the wave itself and around the propagation axis D of the wave itself.

More precisely, the OAM associated with an electromagnetic wave is characterized by an integer quantity, positive or negative, which expresses the number of complete rotations (i.e. 360 degrees) made in the wavefront within a distance equal to the wavelength in a left- or right-handed sense.

An electromagnetic wave with non-zero OAM has a region in which the electromagnetic field, in a neighborhood of the line coincident with the direction of propagation, also known as the electromagnetic vortex, has an intensity and amplitude close to zero. This phenomenon is due to diffraction effects in the remote transmission of the electromagnetic wave.

Electromagnetic waves with an integer value of OAM have a characteristic intensity structure with an axial symmetry in the form of concentric rings characterized by different values of electromagnetic field intensity on a plane orthogonal (in jargon “doughnut”) to the propagation axis, and a phase structure characterized by a finite number of spirals wrapped along the direction of propagation D and formed by the phase of the wavefront, properties independent, in the far field, from the polarization state of the wave itself (in jargon “fusilli”). In this case, it is said that the electromagnetic wave has a well-defined spatial structure of phase and amplitude that is preserved during propagation in a preferably homogeneous medium.

The present invention associates at least two independent data transmission channels with an electromagnetic wave having a certain carrier frequency and a certain OAM.

The definition of “data transmission channel” (or “data channel”) is used here to indicate a signal that carries information, without any limitation regarding the type of said signal (audio, video, multimedia, digital data exchange, etc.) or the technological method used for its generation and transmission, including for example both analog and digital.

Multi-user omnidirectional distribution using OAM states benefits from the multiplication of the data transmission channels, preferably after a topological transformation of the wavefront that sees as a singularity of coordinates the intersection of the measurement plane (or surface) with the D axis of propagation of the OAM wave transformed into an axis of symmetry coincident with D in a propagation orthogonal to it following the rules of geometric anamorphic transformations of affine homology, as in the case of a directional OAM beam characterized by a doughnut-shaped wavefront with the vortex at the center (which is always characterized by having zero field intensity and is the center of symmetry for any integer value of OAM) when it reflects on the surface of a cone whose axis coincides with the propagation axis of the electromagnetic waves beam (D axis) and is thus reflected omnidirectionally on a plane perpendicular to the D propagation axis.

In the case of a single OAM mode with known symmetry of the field intensity with respect to the D axis on the plane orthogonal to it, the anamorphic transformation of affine homology transforms this figure into a wavefront with conical or preferably cylindrical symmetry, preserving the intensity symmetry of the electromagnetic field and transforming the original “fusilli” spatial phase structure into a spiral centered on D, whose pitch is determined by the phase shift imposed by the value of the OAM itself.

As indicated above, the present invention provides an apparatus and a method for the creation of a radio link that allow each individual OAM channel to be multiplied by dividing the wavefront of each OAM electromagnetic wave into different sectors that share the same carrier, which is modulated independently in amplitude, frequency, polarization, or phase in each of these sectors.

In this way we preserve the physical and structural properties of the original carrier wave, guaranteed by the well-known topological stability of OAM waves during propagation, thus increasing the data transmission capacity of each wave and its stability after propagation by dividing the wavefront into sectors.

The definition of “carrier” or “carrier wave” is used here to indicate a generic electromagnetic wave or electrical signal with known frequency, amplitude, polarization, and phase characteristics, which is modified by a modulating signal, usually containing information, and then transmitted over the air or in other ways used by current art such as for instance fiber, waveguide or cable.

The definition of “sector” is used here to indicate a portion of the wavefront of the OAM electromagnetic wave that preserves its structure during its propagation toward at least one receiving Rx user.

### Practical Examples

As mentioned, in general the present invention refers to an apparatus 1 for creating a radio link with waves propagating along the propagation axis D, and to an configuration of such apparatus where, alternative following an anamorphic transformation of affine homology, the wavefront of such electromagnetic waves propagates with cylindrical or conical symmetry in directions orthogonal to the axis itself. In each of the configurations, the wavefront of the sample electromagnetic wave W is divided in a plurality of example S1-Sp in which the wavefront is modulated independently.

Apparatus 1 includes a plurality of transmission antennas T1, T2, . . . , TN capable of transmitting an electromagnetic wave, W1, in OAM mode and characterized by a precise and integer value OAM1=11, and at least one other wave W2 with a different value OAM2=12, which in this case form a pair of electromagnetic waves.

The OAM value of at least one wave is mandatorily different from 0, but it is not excluded that the antennas can simultaneously generate also “standard” waves with OAM=0, which can be used, for example, as a jamming channel in the same frequency of the other waves. As mentioned, the plurality of antennas T1, T2, . . . , TN is preferably suited to transmit a set of electromagnetic waves W1, W2, . . . , Wk with different OAM values and to independently modulate each of the OAM carriers in selected sectors S1, S2, . . . , Sp of each wavefront.

The electromagnetic waves W1, W2, . . . , Wk have the same carrier frequency, preferably in the range between 30 KHz and 300 GHz, and propagate uniformly so that the wavefront propagates along directions orthogonal to a given axis having direction D, or alternatively along the axis itself.

Preferably, apparatus 1 comprises a plurality of transmission antennas T1, T2, . . . , TN arranged on a transmission plane T orthogonal to direction D and suited to transmit the pair of electromagnetic waves W1, W2 along the propagation directions orthogonal to D.

Preferably, the transmitting antennas T1, T2, . . . , TN are arranged in correspondence with a set of transmission points t1, t2, . . . , tN belonging to the transmitting surface T.

Preferably, the transmitting antennas T1, T2, . . . , IN are positioned along at least one circumference or ellipse lying on said transmitting surface T.

The transmission antennas T1, T2, . . . , TN are preferably arranged on a single circumference or ellipse lying on the transmission plane T and centered on axis D. Some forms of implementation (not illustrated) of the present invention may, however, envisage that the transmitting antennas T1, T2, . . . , TN be arranged on several concentric (or confocal) circumferences or ellipses on the same plane orthogonal to D or on planes parallel to or sharing a single attachment point on the A axis and open in a radial pattern.

Preferably, second piloting means 10 can be electronic means operationally associated with the transmission antennas T1, T2, . . . , TN to regulate the transmission of electromagnetic waves W1, W2.

The piloting means 10 can include any type of analog or digital circuit, as needed.

The transmission of electromagnetic waves W1, W2 can take place with known multiplexing modalities. For example, the piloting means 10 can drive the transmission TN antennas T1, T2, . . . , TN through corresponding transmission signals, each of which is characterized by a different phase.

In this way, the array of transmission antennas T1, T2, . . . , TN can easily generate electromagnetic waves W1, W2, . . . , Wk superimposed on each other but characterized by a different orbital angular momentum.

Preferably, in the configuration shown in FIG. 1, the axes of the transmitting antennas T1, T2, . . . , TN are oriented so that they converge at a midpoint between the transmission plane T and the receiving plane R, along the propagation direction D.

Alternatively, in the configuration of FIGS. 2, 3 and 4 obtained with the anamorphic transformation of affine homology, the axes of the transmitting antennas T1, T2, . . . , TN are oriented in such a way as to converge at a midpoint of common junction between the transmission plane T and the concentric receiving surface R, in directions orthogonal to the propagation direction D.

In some forms of implementation of the present invention, the transmission antennas T1, T2, . . . , TN may consist of very simple structures, e.g. Yagi-Uda antennas, rotation paraboloids, holes in metal shields or “backfire antennas”, thereby reducing the costs of building the transmission system of apparatuses 1,101.

Preferably, to further improve their directivity, transmitting antennas T1, T2, . . . , TN can be made using dielectrics, complex optical schemes, metamaterials and/or plasmonic materials.

Preferably, the piloting means 10 are able to associate at least one transmission channel Chx, x to the electromagnetic wave W1 superimposed on waves W2, . . . , Wk.

To this end, means of encoding, including known ones, can be operationally associated or integrated to/in the piloting means 10 to transmit data along the Chx, x transmission channel.

Preferably, the modulation means 11 independently modulate the wavefronts in the wavefront sectors (S1, S2, . . . , Sp) using as carrier waves each of the electromagnetic waves with OAM≠0 (i.e., both 0> and 0< are possible).

Preferably, the regulation means (not illustrated) of the polarization state of electromagnetic waves W1-Wk are operationally associated or integrated to/in the modulation means 11.

In this way, the data transmission channels can be doubled using the degree of freedom offered by polarization.

Preferably, the transmitting antennas T1, T2, . . . . TN are able to transmit multiple electromagnetic waves W1-Wk and to associate each electromagnetic wave to at least one different transmission channel Chx, x for each S1-Sp sector of the wavefront.

The receiving device 3,103 in general comprises a plurality of receiving antennas R1, R2, . . . , RM capable of simultaneously receiving a W1, W, . . . , Wk set of these electromagnetic waves superimposed on each other. The W1, W2, . . . , Wk set of electromagnetic waves is preferably used for the transport at a distance of k*P different signals of data channels (where k is the number of waves and P the number of sectors of each wavefront) with carriers P1, P2, . . . , Pk respectively associated with them.

The electromagnetic waves W1, W2, . . . , Wk are characterized, respectively, by different orbital angular momenta, e.g., a first and second orbital angular momentum m1, m2, . . . , mk, where m1, m2, . . . , mk are different integers, positive or negative. Possibly, one of the electromagnetic waves W1, W2, . . . , Wk can have zero orbital angular momentum (in this case it is not a twisted wave but it can still be used for example for jamming modulation).

The carriers P1, P2, . . . , Pk of each of the electromagnetic waves W1, W2, . . . , Wk can be modulated separately and independently in different sectors S1, S2, . . . , Sp, to increase the capacity of each wave by at least p times the capacity compared to a channel exploiting the entire wavefront. Each of the Sj sectors, 1≤j≤p, can be advantageously used as an independent data channel to distribute information along a given direction toward different users.

As schematically illustrated in FIG. 1, on the path to the receiving antennas R1, R2, . . . , RM the wavefront of each of the electromagnetic waves W1, W2, . . . , Wk rotates around the propagation axis D, on the generic plane orthogonal to this direction of propagation. The electric field of each of the electromagnetic waves thus draws a set of helical trajectories in space that extends along the direction of propagation D (helical axis).

As mentioned above, angular momenta express the number of complete rotations made by the wavefront of the electromagnetic waves respectively, per wavelength, while the rotation direction of the wavefront of each of the electromagnetic waves is expressed by the modulus and sign of its orbital angular momentum.

The receiving antennas R1, R2, . . . , RM are arranged on a receiving surface R, which in FIG. 1 we identify with a plane intersecting the propagation direction D of the electromagnetic waves and positioned at a distance Z with respect to a transmission source T of the electromagnetic waves themselves.

Preferably, the receiving antennas R1, R2, . . . . RM are arranged in correspondence with a plurality of points r1, r2, . . . , rM belonging to the reception plane R and suitably positioned to use each of the observation sectors Sr1, Sr2, . . . , Srp corresponding, at least in pairs, to the wavefront sectors S1, S2, . . . , Sp composing the electromagnetic waves W1, W2, . . . , WK.

Preferably, the receiving antennas R1, R2, . . . , RM are positioned along at least one circumference or closed curve lying on R and centered on the propagation direction D of electromagnetic waves W1, W2, . . . , Wk.

The receiving antennas R1, R2, . . . , RM are preferably arranged on one or more circumferences or closed curves on the receiving plane R.

The number M of receiving antennas may vary as needed.

The number p of the sectors of each of the electromagnetic waves W1, W2, . . . , Wk can advantageously vary according to each emitted wave.

Preferably, M is an even number greater than or equal to two.

The reception plane R is preferably arranged in such a way as to be substantially orthogonal to the propagation direction D of the electromagnetic waves W1, W2, . . . , Wk.

The receiving device Rx 3, 103 includes the discrimination means 20, e.g. electronic means, operationally associated with the receiving antennas R1, R2, . . . , RM.

The discrimination means 20 may include any type of analog or digital circuit, as required.

The discrimination means 20 are suited to perform, in correspondence with the observation sectors Sr1, Sr2, . . . , Srp, amplitude and phase measurements of the electromagnetic field on the receiving plane R, in order to acquire the first DATA1 data.

The discrimination means 20 are also suited to process the DATA1 data obtained from the above-mentioned amplitude and phase measurements of the electromagnetic field ER, to separate the OAM channels associated with waves W1, W2, . . . . Wk, and to derive the DATA2 data, to subdivide and identify each OAM carrier in each of the sectors Sr1, Sr2, . . . , Srp.

The discrimination means 20 are also able to further process the DATA2 data thus obtained, in order to obtain third DATA3 data by decoding each generic channel obtained by multiplying with analog or digital Chx, x, techniques the OAM data channel in the corresponding sector Sj of the generic OAM electromagnetic wave Wq, 1≤q≤k, for example in such a way that the final output signal from the Rx receiving device of apparatus 1,101 contains one and only one of said data channels.

Preferably, the discrimination means 20 receive from each of the receiving antennas R1, R2, . . . , RM a receiving signal detected at one of the observation points r1, r2, . . . , rM.

By processing the DATA1 measurement data, indicative of the amplitude of the resulting electromagnetic field ER, on the receiving plane R, it is therefore possible to recognize the function that expresses the distribution of the amplitude electromagnetic field, on the receiving plane R, and thus obtain the DATA2 data, indicative of the difference between the angular momenta of the electromagnetic waves W1, W2, . . . , Wk and their separation in reception. As explained above, the discrimination means 20 are able to acquire the DATA2 data, indicative of the difference between the various OAM waves.

Preferably, as mentioned above, multiple channels can be associated with each OAM wave by independently modulating non-overlapping sectors of the wavefront.

In the receiving device Rx 3,103, the acquisition of data transmitted through data channel C can be advantageously carried out thanks to appropriate decoding means (not illustrated), known type, even of a operationally associated with or integrated to/in the discrimination means 20.

Preferably, the receiving antennas R1, R2, . . . . RM are able to receive multiple electromagnetic waves W1, W2, W3, W4 (FIG. 1) in the wavefront sectors taken as example, S1, S2.

Preferably, the receiving antennas R1, R2, . . . , RM are movable on the receiving surface R as required.

The position of the observation points r1, r2, . . . , rM on the receiving surface R can thus vary as needed, in order to optimize the reception of the superimposed electromagnetic waves W1, W2, . . . , Wk. Preferably, the observation points r1, r2, . . . , rM are located in a neighborhood of the points of maximum of the modulus of the electromagnetic field ER.

The receiving antennas R1, R2, . . . , RM may consist of dipoles, paraboloids, or other structures of known type. Metamaterials and/or plasmonic materials can be advantageously used for their realization.

The number N of receiving antennas can vary as needed. Preferably, that number N is an even number greater than or equal to two.

In general, in the use of the remote radio link made by the present invention, the following steps can be performed:

Activating sections of the transmitting antenna in order to transmit an analog or digital communication channel in a well-established direction obtained by appropriate analog or digital modulation.

Activating said sections of the transmitting antenna so that only the receiving station is illuminated, and preferably transmitting a jamming modulation in the remaining directions.

Directing the transmission with an active feedback method in order to optimize the transmission of information to the recipient.

Receiving at least one of the electromagnetic waves W1, with orbital angular momentum OAM=11, in correspondence with a receiving surface R, intersecting the propagation direction D, or alternatively, in the directions orthogonal to D, following an anamorphic transformation of affine homology of the wavefront, and positioned at a distance with respect to at least one source T of the electromagnetic waves W1, W2, . . . , Wk.

Carrying out amplitude and phase measurements of the electromagnetic field in order to acquire the first DATA1 data indicative of the amplitude and phase distributions of the electromagnetic field ER resulting from the superimposition of electromagnetic waves W1, W2, . . . , Wk, in correspondence with said observation points r1, r2, . . . , rM.

Processing the first DATA1 data to obtain the second DATA2 data that allow the separation of the electromagnetic waves W1, W2, Wk into carrier signals for each chosen wavefront sector S.

Preferably, it is also possible to process the second DATA2 data in order to obtain third DATA3 data that make it possible to discriminate, if present, multiplexed data transmission channels in the various sectors, S.

Preferably, the method, according to the invention, also includes the steps of:
identifying, on the receiving surfaces R, the points of maximum and minimum of the electromagnetic field ER resulting from the superimposition of the electromagnetic waves W1, W2, . . . , Wk;
identifying the observation points r1, r2, . . . , rM according to the number and position of said points of minimum in the various wavefront sectors S;
merging the channels of each wavefront sector to increase the data transfer capacity of a single OAM wave;
associating one or more different users to each of the wavefront sectors S for single or broadcast data transmission.

It has been seen in practice that the apparatus and the method, according to the invention, allow to solve the drawbacks described in the known art, achieving the set goals by associating multiple channels and multiple users to the same single OAM value.

The apparatus and the method, according to the invention, provide for simple amplitude and phase measurements of the electromagnetic field to detect this identifying characteristic quantity in the chosen sectors of the wavefront.

The apparatus and the method, according to the invention, are thus relatively simple and inexpensive to implement in practice, compared to the telecommunication systems and methods of the known art.

The apparatus and the method, according to the invention, involve the use of receiving/transmitting antennas with very simple geometries and easy to use in practice.

### General Interpretation of Terms

In understanding the purpose of this invention, the term “comprehending” and its derivatives, as used herein, are understood to be open-ended terms that specify the presence of the stated features, elements, components, groups, integers, and/or phases, but do not exclude the presence of other undeclared features, elements, components, groups, integers, and/or phases. The above also applies to words that have similar meanings such as the terms “including”, “having” and their derivatives. In addition, the terms “part”, “section”, “portion”, “member” or “element” when used in the singular may have the double meaning of a single part or a plurality of parts. As used here to describe the form(s) of actuation above, the following directional terms “forward,” “backward,” “above,” “down,” “vertical,” “horizontal,” “below,” and “transverse,” as well as any other similar directional term, refer to the actuation form described in operative position. Finally, grade terms such as “substantially,” “about,” and “approximately” as used here mean a reasonable amount of deviation of the modified term such that the final result is not significantly changed.

While only selected embodiments have been chosen to illustrate the present invention, it will be clear to experts in the field from this description that various modifications and variations can be made without straying from the scope of the invention as defined in the attached claims. For example, the size, shape, position, or orientation of the various components can be changed as needed and/or desired. Components shown that are directly connected or in contact with each other may have intermediate structures arranged between them. The functions of one element can be performed by two and vice versa. The structures and functions of f one form of realization can be adopted into another form of realization. It is not necessary for all the benefits to be present in a particular form of realization at the same time. Any feature that is original compared to the known technique, alone or in combination with other features, should also be considered a separate description of further inventions by the applicant, including the structural and/or functional concepts incorporated by those features. Therefore, the foregoing descriptions of the embodiments under the present invention are provided for illustrative purposes only and not for the purpose of limiting the invention as defined by the attached claims and their equivalents.

1. Set of telecommunication channels comprising a plurality of first channels in the same carrier frequency, the set comprising at least one first carrier electromagnetic wave (W1) carrying orbital angular momentum, i.e., with the phase twisted around a predetermined twisting axis, the wavefront of said wave being divided in space into propagation sectors distinct from each other, where each of said first channels comprises:
said orbital angular momentum of said first wave;
one of said sectors of said first wave in which said wave is modulated differently from the other sectors.

2. Set according to claim 1, wherein the sectors are placed side by side circumferentially around said twisting axis.

3. Set according to claim 1, further comprising at least one second carrier electromagnetic wave carrying orbital angular momentum, i.e. with the phase twisted around a predetermined twisting axis with the same frequency as said first wave, the first and second waves being characterized by different orbital angular momenta, where the set of channels includes a plurality of second channels, comprising:
said orbital angular momentum of said second wave;
a propagation sector among a plurality of propagation sectors into which the front of said second wave is subdivided, where said second wave is modulated in said sector in a different way from its other sectors.

4. Set according to claim 3, wherein the two waves have a common source of transmission.

5. Set according to claim 4, wherein the two waves have the same twisting axis, where their propagation sectors coincide.

6. Set according to claim 1, wherein at least one of said channels is defined by a modulation of at least one communication signal, while at least one of the other channels is defined by a jamming modulation.

7. Set according to claim 1, wherein said channels are omnidirectional.

8. Multi-channel telecommunications apparatus comprising at least one radio transmitting device, hereinafter referred to as Tx for brevity, and at least one radio receiving device, hereinafter referred to as Rx for brevity, wherein:
the Tx transmission device comprises:
a plurality of transmitting antennas (T1-Tn);
a plurality of modulation sections each defined by a group of said antennas operationally associated with each other;
piloting means, configured to drive said T1-Tn antennas to generate at least one carrier electromagnetic wave with the phase twisted around a predetermined twisting axis characterized by an orbital angular momentum and by a carrier frequency;
modulation means operationally associated with said sections configured to modulate corresponding sectors of the front of said electromagnetic wave with orbital angular momentum, where the modulations of sectors are independent of each other and define respective channels in the same carrier frequency.

9. Apparatus according to claim 8 wherein said at least one Rx receiving device is placed at a distance from the Tx transmitting device and includes:
a plurality of receiving antennas;
discrimination means, operationally associated with said receiving antennas and configured to take measurements at different reception points in order to acquire first data indicative of the discrimination of said electromagnetic wave and to process them into second data indicative of the discrimination of said sectors of the respective wavefront.

10. Apparatus according to claim 9, wherein the discrimination means are configured to perform at least phase measurements, preferably amplitude and phase measurements.

11. Apparatus according to claim 9, wherein the discrimination means are configured to process said second DATA2 data in order to obtain third DATA3 data which make it possible to discriminate in different sectors of the various wavefronts, which correspond to as many data transmission channels, if modulations of data signals are present.

12. Apparatus according to claim 9, wherein the Tx transmission device is configured to generate a plurality of said carrier electromagnetic waves with the phases twisted around predetermined twisting axes with different orbital angular momenta, where said discrimination means are configured to discriminate said electromagnetic waves each compared to the other.

13. Apparatus according to claim 9, where the receiving antennas are mobile among a plurality of different observation points.

14. Apparatus according to claim 13, wherein the observation points are points of maximum and minimum of the electromagnetic field ER resulting from the superimposition of said electromagnetic waves on a receiving surface.

15. Apparatus according to claim 8, wherein:
the Tx transmitting device comprises a plurality of transmitting antennas arranged in one of the following ways:
A) the transmitting antennas are arranged to define a transmitting surface and a predetermined twisting axis of the wave;
the Rx receiving device (2,102) comprises a plurality of receiving antennas arranged in one of the following ways:
B) the receiving antennas are arranged to define a receiving surface intersecting the twisting axis;
C) the receiving antennas are arranged in a radial pattern around a predetermined axis.

16. Apparatus according to claim 8, wherein the piloting means modulate in at least one of the following: phase, amplitude, polarization, frequency, path diversity, and other methods of known art.

17. Apparatus according to claim 16, wherein the modulation means modulate in at least one of the following: phase, amplitude, polarization, frequency, path diversity, and other methods of known art.

18. Apparatus according to claim 8, wherein it includes directional feedback means configured to orient the reciprocal positions of the transmit and receive directions.

19. Apparatus according to claim 8, wherein the modulation means include means for regulating the polarization state of electromagnetic waves.

20. Multi-channel telecommunications procedure comprising the following steps:
generating at least one carrier electromagnetic wave carrying orbital angular momentum, i.e., with the phase twisted around a predetermined twisting axis characterized by an orbital angular momentum and by a carrier frequency;
dividing the wavefront into sectors modulated independently of each other and considering each one as a transmission channel in said carrier frequency; and
receiving the wavefront and discriminating said channels.

21-26. (canceled)
